(19) United States
(12) Patent Application Publication
(10) Pub. No.: US 2025/0231025 A1
(43) Pub. Date: Jul. 17, 2025

(54) A SYSTEM AND METHODS FOR NEAR REAL-TIME SYNOPTIC BATHYMETRY AND FORECASTING

(71) Applicant: WATER INSTITUTE OF THE GULF, Baton Rouge, LA (US)

(72) Inventors: Michael D. Miner, New Orleans, LA (US); Andrew Courtois, Jefferson, LA (US); Jason P. Curole, New Orleans, LA (US); Nicholas C. Howes, Ashland, MA (US); Harris C. Bienn, Baton Rouge, LA (US); Diana R. Di Leonardo, Queens, NY (US); Christian Ariza Porras, Baton Rouge, LA (US); John Marshall Swartz, Denver, CO (US)

(21) Appl. No.: 18/854,027

(22) PCT Filed: Apr. 4, 2023
(86) PCT No.: PCT/US23/65337

§ 371 Date: Oct. 3, 2024

Related U.S. Application Data
(60) Provisional application No. 63/362,504, filed on Apr. 5, 2022.

(51) Int. Cl. G01C 13/00

(52) U.S. Cl. CPC G01C 13/008

(57) ABSTRACT

Methods and systems for determining depths of a waterway are disclosed. A system may receive depth data measured by a vessel in a waterway, the depth data being a part of crowdsourced depth data measured by multiple vessels. To achieve a standardization of the depth data measured by multiple vessels, the system may transform the depth data to elevation data, the transforming based on an elevation standard and a location having an established elevation. The location may be determined from a bathymetric survey that includes the established elevation, a fixed point in the waterway, or a crossing of a track of the vessel with a track of another vessel having the established elevation. Waterway depths, universally based on the elevation standard, may be determined based on the elevation data.

### BACKGROUND

An important aspect of commerce is the transportation of goods. In addition to railroads and trucks, vessels travelling via waterways, such as rivers, large lakes, and oceans, are capable of carrying huge quantities of commercial goods and materials. In contrast to highways for trucks and railroads for railcars, features and conditions of waterways are often not static. For example, depths of rivers or other water bodies generally change seasonally or even day to day due to variable volume flow, currents, and tides. Thus, there is generally an uncertainty regarding depths of any particular part of a river. Such uncertainty may give rise to questions such as whether there is enough depth (e.g., draft) for travel or to berth a ship at a particular location on a particular afternoon or will dredging be needed in a particular month of the year.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic top view of a waterway that is partially surveyed, according to some embodiments.

FIG. 2 is a schematic top view of a waterway that illustrates example vessel tracks, according to some embodiments.

FIG. 3 is a schematic cross-section of a vessel in a waterway, illustrating various elevations, according to some embodiments.

FIG. 4 is a flow diagram of a process for producing primary status vessel data from raw vessel data, according to some embodiments.

FIG. 5 is a flow diagram of a process for producing secondary and tertiary status vessel data from raw vessel data, according to some embodiments.

FIG. 6 is a flow diagram of a process for producing a shoaling report or forecast, according to some embodiments.

FIG. 7 is a flow diagram of a process for determining depths of a waterway, according to some embodiments.

FIG. 8 is a flow diagram of a process for determining depths of a waterway, according to other embodiments.

FIG. 9 is a flow diagram of a process for producing a bathymetric map of a waterway, according to some embodiments.

FIGS. 10-17 illustrate a process for producing a shoaling report, forecast, or a bathymetric map of a waterway, according to some embodiments.

### DETAILED DESCRIPTION

This disclosure describes techniques and systems to determine or forecast depths of vessel-carrying waterways or water bodies, such as rivers, coastal inlets, harbors, port berths, navigation channels, and canals, just to name a few examples. Some of the techniques involve a process of receiving raw, crowdsourced depth data measured by multiple vessels (e.g., boat, ship, tug, autonomous underwater or surface vehicle (AUV or ASV), etc.) and using calibrated survey data referenced to a standard vertical datum, in combination with water surface elevation data, to convert crowdsourced depth data to a standardized elevation or depth that may be universally recognized by multiple users. For example, such calibrated survey data may be referenced to NAVD88, though various embodiments described herein may use other survey data that reference other vertical datum (e.g., MLLW). Crowdsourcing generally involves a relatively large group of dispersed participants (e.g., vessels in various parts of a waterway at different times) contributing or producing depth data to achieve a cumulative result. In other embodiments, crowdsourcing need not be involved and time series data from various other sources may instead be used.

There are a number of advantages provided by using crowdsourced depth data. For example, such crowdsourcing allows for the use of existing sensors on vessels and use of depth measurements thereof that already exist in the course of normal travel of the vessels. Crowdsourcing also allows for increasing data volume and frequency while maintaining various costs. Unfortunately, each vessel generally has its own characteristics regarding its depth measurements. For example, exact locations on the river for where depth measurements were taken, location (relative to the GPS coordinate of the vessel) and depth of the transducer taking the depth measurements, the tide or elevation of the water surface at the time of the depth measurement, and other factors are generally unique for each vessel and for each depth measurement. Thus, embodiments described herein introduce the application of standardized, universal survey data to the crowdsourced depth data so that this depth data may be calibrated to this standard. In this way, substantially all the variables and inconsistencies among the multiple vessels may be removed so that depth data measured by one vessel is consistent with (e.g., in parity with) depth data measured by another vessel.

Herein, vessel depth is the distance from a depth transducer on the hull of a vessel to the bottom of the waterway underlying the vessel. Even for a specific location, measured depth generally varies, being dependent on water surface elevation, vessel draft, location of the depth transducer in the hull of the vessel, and other factors. Water level (e.g., elevation) generally changes daily and seasonally. Herein, a system may use elevation as a standardized value that is corrected to ensure geopotential parity across geographic locations and is independent of variables that affect waterway depth.

Survey data may be provided to a system by any of a number of entities, such as port authorities (e.g., Port of New Orleans) or the US Army Corps of Engineers, for example. Such survey data may be corrected to a known elevation and referenced to a standard, such as the NAVD88. Using a cloud of data points in a survey, the system may create an interpolated 2-dimensional surface of the data, such as a triangulated irregular network (TIN). NAVD88 elevations may then be applied to the TIN to create a surface that comprises NAVD88 elevations.

In some embodiments, a system may be deployed to any vessel having a processor (e.g., that executes programmable code) that is integrated with sensors or receivers to receive crowd-sourced data. System capabilities may include harvesting and packaging data that is sourced from existing sensors (e.g., including but not limited to sensors such as GPS, depth sounder, water quality, wind gage, temperature gage, etc.) aboard the vessel and transmitting data to cloud storage in real-time via telemetry (e.g., satellite, radio, and cellular, just to name a few examples). The system may be agnostic to sensor type and may utilize a standard data format, such as that associated with the National Marine Electronics Association (NMEA). The system may receive raw, crowd-sourced vessel depth data from a number of vessels. The system may filter the data, as described below, to produce a unique, crowd-sourced data set for each vessel. In embodiments where data provided by each vessel are in the form of a depth, which may have limited utility, to ensure that all vessel data are referenced to a common vertical datum), vessel depth may be converted to a NAVD88 (or other standard) elevation. For a vessel, a process for such conversion may include identifying areas of overlap between a track of the vessel and one or more points that have an established (e.g., known) elevation. For example, points with known elevation may be derived from an archived bathymetric survey that is referenced to an established vertical datum. A vessel, however, may need to cross at least one point within such a survey to convert the vessel depth to an elevation. In another example, a vessel depth measured on a fixed structure on the water bottom of known elevation (e.g., a shipwreck, a concrete revetment or other engineered structure, bridge footing, or pipeline crossing) that can be assumed to be stationary (at least during time spans or an epoch of interest) may be used as a reference elevation from which to convert vessel depth to an elevation. In still another example, an elevation of a vessel may be determined if the vessel crossed a track of another vessel that has been corrected to a known elevation. In such a case, a status may be assigned to each vessel based on the source used to establish its elevation so as to convert the vessel's depth to a value that references a universal standard vertical datum. For example, a vessel that has crossed tracks with either one or more survey points or a fixed point in the waterway of known elevation and uses either one of these for a reference to correct vessel depth to an elevation may be assigned a primary status. Determined depths or elevations of primary status vessels may be considered relatively highly accurate. A vessel that has crossed tracks with a primary vessel and relies on the reference elevation of the primary vessel at the point of the track crossing may be assigned a secondary status. Depths or elevations of a secondary status vessel may be determined by an intermediate transformation using depths or elevations of a primary vessel. Depths or elevations of a secondary status vessel may be considered to be less accurate than those of a primary status vessel because the transformation may introduce some errors. A vessel that has crossed tracks with a secondary vessel and relies on the reference elevation of the secondary vessel at the point of the track crossing may be assigned a tertiary status. Depths or elevations of a tertiary status vessel may be determined by an intermediate transformation using depths or elevations of a secondary vessel. Depths or elevations of a tertiary status vessel may be considered to be less accurate than those of a secondary status vessel because the transformation may introduce some errors. Generally, vessel status may change on a regular basis, from time to time, or based on distance travelled, and thus status may be reassigned as situations change for the vessel.

In some embodiments, a method for determining depths (which may be performed in near real-time in some implementations) of a waterway may include receiving depth data that is a part of crowdsourced depth data measured by multiple vessels in the waterway. The depth data may then be transformed to elevation data. The transforming, which may be an automatic process, may be based on an elevation standard, such as NAVD88, and a fixed location having an established elevation. Such a location may be determined from a bathymetric survey that includes the established elevation. In other situations, as mentioned above, the location may be a fixed point, such as a shipwreck or a submerged pipeline crossing, in the waterway or a crossing of a track of the vessel with a track of another vessel having an established elevation. Depths of the waterway may be determined based on the elevation data.

In some implementations, as mentioned above, the method may also include assigning a status to each of the multiple vessels based on quality of the depth data provided respectively by each of the multiple vessels. The status of a vessel, as described below, may then be considered when processing depth data measured by that vessel. For example, a primary status may correspond to a relatively high quality of the depth data, a secondary status may correspond to a relatively medium quality of the depth data, and a tertiary status may correspond to a relatively low quality of the depth data (as compared to the other data just described). Such levels of quality may be identified and considered during a process of transforming crowdsourced depth data to standardized elevation data, for example.

In some embodiments, a method for determining depths of a waterway may include receiving crowdsourced depth data measured by multiple vessels and transforming the depth data to elevation data. As described above, the transforming may be based on a standard elevation surface, such as NAVD88, and a type of established elevation point. The method may further include establishing a hierarchy of accuracy of the elevation data by categorizing, or assigning a status to, each of the multiple vessels. The categorizing may be based on the type of the established elevation point used to transform the depth data to the elevation data. For example, a vessel may be categorized as a primary status vessel, corresponding to relatively high accuracy elevation data, if the type of established elevation point is a surveyed part of the waterway or a fixed point of known elevation in the waterway. Also, a vessel may be categorized as a second status vessel, corresponding to relatively medium accuracy elevation data if the type of established elevation point is a track crossing with one of the primary status vessels. Further in the hierarchy, a vessel may be categorized as a tertiary status vessel, corresponding to relatively low accuracy elevation data (as compared to the other data just described), if the type of established elevation point is a track crossing with one of the second status vessels. Depths of the waterway may be determined based on the high, medium, and low accuracy elevation data.

In some implementations, the status of a particular vessel among the multiple vessels may change in response to an expiration of a time span of validity or the particular vessel traveling beyond a threshold distance, for example. In other implementations, vessels may move outside the region of a survey and still provide elevation “in-datum”, as long as the water surface elevation is known and vessel transducer offset is established, for example.

In some embodiments, a method for producing a bathymetric map of a waterway may include receiving crowdsourced depth data measured by multiple vessels, transforming the depth data to elevation data, compiling the elevation data with survey data, creating a digital elevation model of a bottom of the waterway, and producing the bathymetric map. The transforming may be referenced to a standard vertical datum, such as NAVD88, and an established elevation point, which may be a surveyed part of the waterway or a fixed point of known elevation in the waterway, as described above and below.

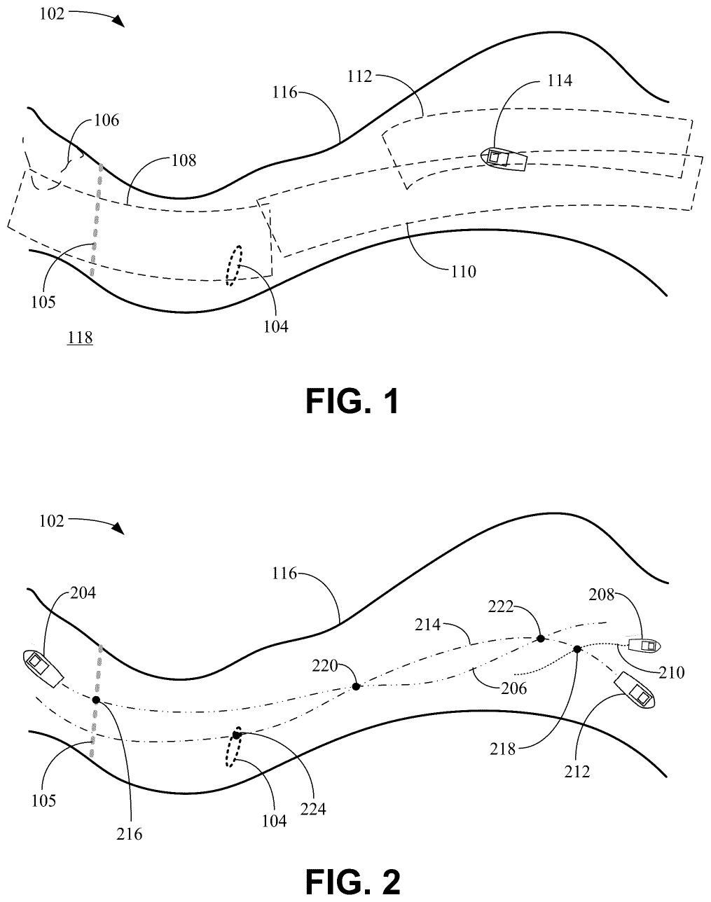

FIG. 1 is a schematic top view of a waterway 102, that is partially surveyed, according to some embodiments. A waterway may be an ocean, river, canal, harbor, inlet, port berth, navigation channel, canal, or lake, but for illustrative purposes herein, waterway 102 is a river. Although rivers are used as examples of a waterway, claimed subject matter is not so limited. A relatively important river in the United States, for example, is the Mississippi River. Several features of waterway 102 are illustrated, including a submerged shipwreck 104, a submerged pipeline crossing 105, and a bedform 106, such as a shoal, submerged ridge, bank, or bar comprising sand or other unconsolidated material. The channel bed itself (bottom of the waterway) is not depicted but is subject to elevation change in terms of net aggradation or degradation with respect to a vertical datum, and shoaling associated with net aggradation relative to the water surface. Such features as illustrated by bedform 106 represent local bathymetric/topographic relief superimposed on a mean channel bed elevation. These features may rise from the channel bed (bottom of waterway 102) into the water column and contribute to or exacerbate shoaling conditions associated with relative change between the water surface and channel bed elevation. This is one example among a number of others (e.g., submerged ridges, banks, or bars that rise to near the water surface) that present a danger to vessel navigation.

In the example illustrated in FIG. 1, a number of surveys, which may comprise archived depth or elevation data, have been performed for this portion of waterway 102. For example, surveys 108, 110, and 112 cover various portions of the waterway. Such surveys may have been performed at various times by various entities. For example, the surveys may comprise archived depth data based on depth measurements performed (e.g., via sonar time-of-flight measurements) by one or more vessels operated (directly or indirectly) by a port authority. Generally different surveys cover different parts of a waterway. Some of the surveys may be much older than other surveys and may be outdated, for example. For at least the reason that different surveys are measured by different vessels and the bottom profile of waterway 102 generally changes over time, survey 110 may include depth data that is different than those of survey 112. Thus, an area of overlap between surveys 110 and 112 has been measured twice and the respective depths presented by the two surveys may likely be different, even if by a small amount. Except for its own real-time depth measurements, a vessel 114 overlying this survey overlap may be presented with an uncertainty of depth under its hull.

In some implementations, the survey data may be used to generate a triangulated irregular network (TIN), which is a representation of a continuous surface made up of triangular facets (e.g., a triangle mesh).

Overlaying waterway 102, banks 116, and land 118 may be a largescale survey that includes particular reference points. Such a survey may be used as a standard reference for smaller surveys. One such survey may define elevations referenced to a standard vertical datum, which is a reference that may be used for deriving vertical positions relative to a known elevation, such as the elevations of Earth-bound features (e.g., terrain, bathymetry, water level, and built structures). An example is the North American Vertical Datum of 1988 (NAVD 88).

FIG. 2 is a schematic top view of waterway 102 that illustrates various vessels, their tracks, and submerged features, according to some embodiments. Objects in this and other figures herein are not necessarily to scale. In particular, a vessel 204 has a track 206, a vessel 208 has a track 210, and a vessel 212 has a track 214. Tracks may be represented by a series of x-y or longitude and latitude coordinates, for example. A point 216 marks an intersection between track 206 of vessel 204 and pipeline crossing 105. A point 218 marks an intersection between track 206 and track 210 of vessel 208. A point 220 marks an intersection between track 206 and track 214 of vessel 212. A point 222 marks another intersection between track 206 and track 214 of vessel 212. A point 224 marks an intersection between track 214 and submerged shipwreck 104.

In some embodiments, a method for determining depths of a waterway includes receiving crowdsourced depth data measured by multiple vessels and transforming the depth data to elevation data. The transforming may be based on a standard elevation surface and a type of established elevation point. As mentioned above, the method may also include establishing a hierarchy of accuracy of the elevation data by categorizing each of the multiple vessels, the categorizing being based on the type of the established elevation point used to transform the depth data to the elevation data. As explained above, a vessel may be categorized as a primary status vessel if the type of established elevation point is a surveyed part of the waterway or a fixed point of known elevation in the waterway. A vessel may be categorized as a second status vessel if the type of established elevation point is a track crossing with one of the primary status vessels. A vessel may be categorized as a tertiary status vessel if the type of established elevation point is a track crossing with one of the second status vessels.

For example, vessel 204 may be categorized as primary status if the type of established elevation point applied to transforming the vessel's depth data to elevation data is a fixed point of known elevation, such as point 216, which is the intersection between track 206 of vessel 204 and pipeline crossing 105, for which the elevation is known. In another example, vessel 212 may be categorized as primary status if the type of established elevation point applied to transforming the vessel's depth data to elevation data is a fixed point of known elevation, such as point 224, which is the intersection between track 214 of vessel 212 and shipwreck 104, for which the elevation is known. On the other hand, vessel 212 may be categorized as second status if the type of established elevation point applied to transforming the vessel's depth data to elevation data is track crossing 222 with primary status vessel 204. Additionally, vessel 212 may be categorized as second status if the type of established elevation point applied to transforming the vessel's depth data to elevation data is track crossing 220 with primary status vessel 204. Vessel 208 may be categorized as tertiary status if the type of established elevation point applied to transforming the vessel's depth data to elevation data is track crossing 218 with second status vessel 212. On the other hand, vessel 208 may be categorized as second status if the type of established elevation point applied to transforming the vessel's depth data to elevation data is track crossing 218 with vessel 212 while it is categorized as primary status.

As indicated above, the status of a vessel may change. In some implementations, a travel distance or time threshold may invoke a status change. For example, a vessel's status may change if a certain time has elapsed, or a certain distance travelled, since the vessel crossed an established elevation point. For instance, vessel 212 may have a primary status from crossing point 224 (the shipwreck) for a predetermined timespan (e.g., time threshold) or travel distance (e.g., distance threshold). If the timespan has passed or the travel distance has been exceeded, then the status of vessel 212 may change to secondary, for example, if track crossing 222 with primary status vessel 204 is used as the established elevation point applied to transforming vessel 212 depth data to elevation data.

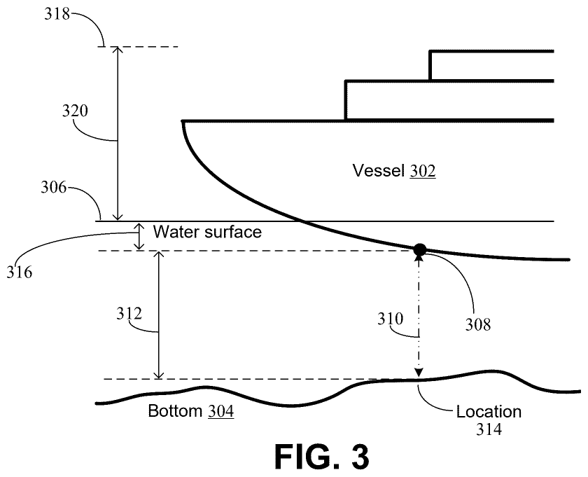

FIG. 3 is a schematic cross-section of a vessel 302 floating or travelling in a waterway, illustrating various elevations, according to some embodiments. The waterway has a bottom 304 and a water surface 306, for which elevations can change with time and/or location. Vessel 302 includes a transducer 308 for measuring depths. Such measurements may be projected forward of the vessel so that, for example, operators of the vessel may measure depths in front of the vessel so as to know upcoming features of the river bottom. For simplicity, however, examples for FIG. 3 are based on transducer 308 pointing downward along vertical line 310 to measure a depth 312 at location 314. Transducer 308 may be located at a distance 316 from water surface 306. A reference elevation standard 318 may be above the water surface by a distance 320, as illustrated, but may be below the water surface in other locations of the waterway. In some implementations, standard reference elevation 318 may be NAVD88, though claimed subject matter is not so limited.

As described above, a system for determining depths of the waterway may perform a method that includes receiving depth data measured by vessel 302. The system may receive the depth data from multiple sensors on the vessel, combine the data, and wirelessly transmit the data in near real-time to cloud storage or other system that includes computer memory and/or a processor. In some implementations, the data need not be transmitted in near real-time. For example, the latter case may occur if vessel 302 temporarily loses its wireless connection for transmitting the data. The data may then be stored locally on the vessel, at least until the data can be wirelessly transmitted to the cloud storage or other system. The depth data may be a part of crowdsourced depth data measured by multiple vessels. In the situation illustrated in FIG. 3, and for simplicity, a single depth measurement, 312, is measured by vessel 302 and provided to the system. For example, vessel 302 may include a transmitter to transmit measured depth data, including depth 312, to the system in real-time or at a later time. The system, which may be located on land, remotely from the waterway and vessel, may then transform depth 312 to an elevation based on elevation standard 318 and a location having an established elevation relative to standard reference elevation 318. As mentioned above, the location may be provided by a bathymetric survey, a fixed point in the waterway, or a crossing of a track of vessel 302 with a track of another vessel having an established elevation. The established elevation associated with vessel 302 may allow depth data measured by vessel 302 to be in parity with other vessels that produce depth data. Thus, the established elevation may compensate for biases or offsets to measured depth due to variables unique to each vessel, such as placement (depth) of the measuring transducer on the hull of the vessel.

For example, at a location/. (not illustrated) that has an established elevation and known water surface 306, vessel 302 measures a depth Dm. The established elevation of that location, however, is D_{ref}. Thus, an offset delta-D) is the difference between D_{ref} and Dₘ (ignoring negative or positive values for the moment), with delta-D) comprising the offset 316 between the vessel transducer 308 and water surface 306 and the offset 320 between the water surface 306 to a vertical datum 318. Once offset 316 between a vessel transducer and water surface is established, in conjunction with a known offset between water surface 306 and vertical datum 318, a correction may be applied to all depth data provided by vessel 302, globally, to continuously resolve delta-D and transform depths to an established elevation, without being dependent on a location L. In some implementations, offset 316 between vessel transducer and water surface may have an associated expiry. In such a case, the offset may be validated and/or updated each time vessel 302 passes over a location/with an established elevation. In other implementations, there is no travel distance or time span limitation regarding the validity of an offset. In view of these details, the system may transform depth 312 in two ways: 1) by applying offset delta-D) to depth 312, which results in an elevation based indirectly on the established elevation at location L, water surface 306, and elevation standard 318, and 2) by applying offset delta-D) to depth 312, which results in an elevation based indirectly on the known offset 316 between the vessel transducer and water surface, and the offset between water surface 306 and the elevation standard/vertical datum 318. In some implementations, a system may continuously and automatically correct depth data using such offsets.

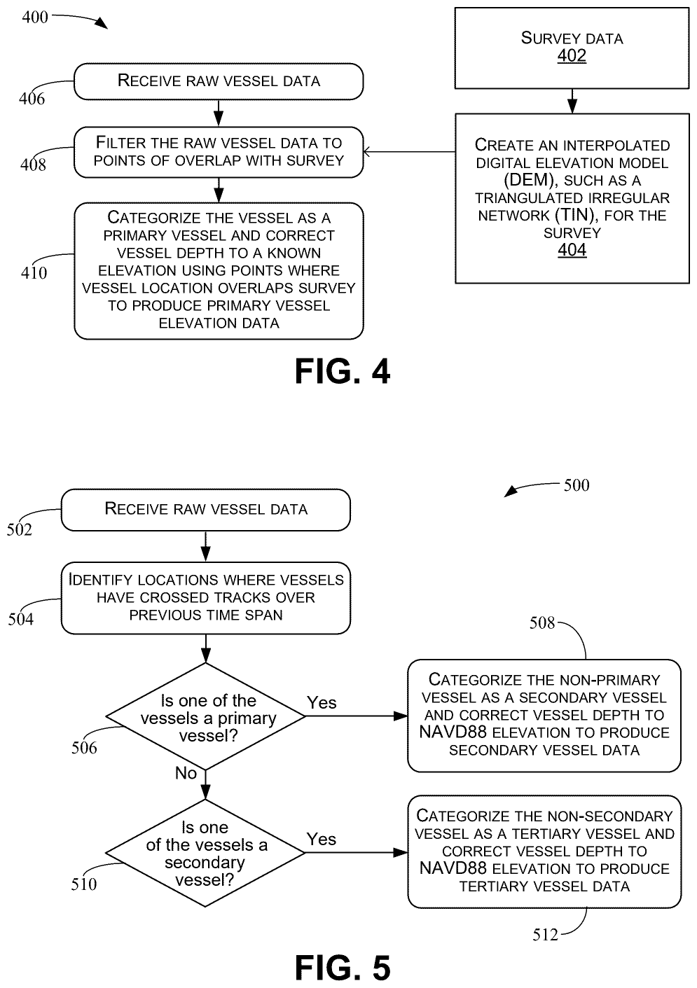

FIG. 4 is a flow diagram of a process 400 for producing primary status vessel data of a waterway from raw vessel data, according to some embodiments. Process 400 may be performed by a system that includes a processor executing programmed instructions, for example. In a sort of background process, the system may perform steps 402 and 404 below to process survey data, wherein no depth-to-elevation conversion is needed. Surveys may be referenced to multiple vertical datums. For example, prior to 402, surveys may be preprocessed and converted to NAVD88. At 402, the system may receive, or have in possession, survey data of an area that includes at least a portion of the waterway. At 404, the system may create an interpolated digital elevation model (DEM), such as a triangulated irregular network (TIN) for the survey, for example. The system may implement other spatial interpolation techniques such as kriging, spline, inverse distance weighting, natural neighbor, or machine learning for DEM creation.

At 406, the system may receive raw vessel data. For example, the raw vessel data may be positioning data (e.g., GPS coordinates of the vessel) and/or depth data measured by a vessel having primary status, as described above, wherein the depth data is a part of crowdsourced depth data measured by multiple vessels. Vessel data in this raw state may be parsed into a standard format and transformed to a unified horizontal coordinate system. Vessel data in this raw state may contain duplicates, outliers, or other data points that may be removed from the data set to increase the signal-to-noise ratio. Data may be filtered to remove duplicated points and ordered by timestamp. When a vessel is stationary, a large number of data points may be collected at a single location. These points may have limited information content and may be removed from the data set using a trained, machine learning supervised classification algorithm. Data points may also not represent a true reading of the water bottom surface (e.g., outliers) and these points may be removed from the data set using a trained, machine learning supervised classification algorithm, for example.

At 408, based on the interpolated DEM created in 404, the system may, in addition to the filtering process described above, filter out vessel data corresponding to locations that do not overlap with the survey. At 410, the system may categorize the vessel (that led to the filtered data) as a primary vessel and correct the vessel's (filtered) depth data to a known elevation using points where vessel location overlaps the survey to produce primary vessel elevation data.

FIG. 5 is a flow diagram of a process 500, which may be performed by the system of process 400, for producing secondary and tertiary vessel data from raw vessel data, according to some embodiments. At 502, the system may receive raw vessel data from a vessel that, in this example, is assumed to be a non-primary status vessel. For example, raw vessel data may be depth data measured by the non-primary status vessel, the depth data being a part of crowdsourced depth data measured by multiple vessels. At 504, the system may identify locations where other vessels have crossed tracks with the track of the non-primary status vessel that provided the raw vessel data. In some implementations, such track crossings may be required to have occurred within a particular time span (e.g., time threshold). At 506, the system may determine whether one of the vessels of a track crossing is a primary vessel, as described above. If so, then process 500 proceeds to 508 where the system may categorize the non-primary status vessel (that provided the raw vessel data) as a secondary status vessel and correct the depth data (e.g., the raw data measured by the non-primary status vessel) to a NAVD88 elevation to produce secondary vessel elevation data. On the other hand, the system, at 506, may determine that one of the vessels of the track crossing is not a primary vessel and process 500 may proceed to 510 where the system may determine whether one of the vessels of a track crossing is a secondary vessel. If so, then process 500 proceeds to 512 where the system may categorize the non-primary vessel (that provided the raw vessel data) as a tertiary status vessel and correct the depth data (e.g., the raw data measured by the non-primary status vessel) to a NAVD88 (or other standard) elevation to produce tertiary vessel elevation data. As explained above, tertiary vessel elevation data may not be as accurate as secondary vessel elevation data, which may not be as accurate as primary vessel elevation data.

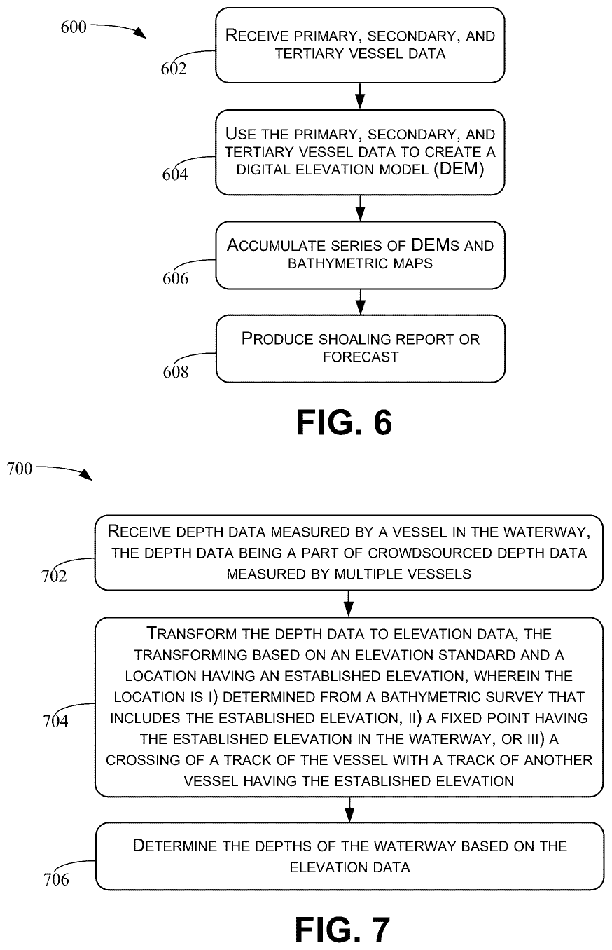

FIG. 6 is a flow diagram of a process 600, which may be performed by the system of processes 400 and 500, for producing a depth (e.g., shoaling) report or forecast, according to some embodiments. At 602, the system may receive primary, secondary, and tertiary vessel data produced by processes 400 and 500. At 604, the system may use the primary, secondary, and tertiary vessel data to create a digital elevation model (DEM). At 606, the system may accumulate multiple series of DEMs and bathymetric maps from archived data, for example. At 608, the system may produce a shoaling report or forecast that may be used by vessel operators. In some implementations, the system may produce a near real-time bathymetric report or forecast. The shoaling report or forecast may comprise depth data at various locations in a waterway.

FIG. 7 is a flow diagram of a process 700 for determining depths of a waterway, according to some embodiments. Process 700 may be performed by a system that includes a processor executing programmed instructions, for example. At 702, the system may receive depth data measured by a vessel in the waterway. The depth data may be a part of crowdsourced depth data measured by multiple vessels, as described above. At 704, the system may transform the depth data to elevation data. The transforming may be based on an elevation standard and a location having an established elevation. The location may be i) determined from a bathymetric survey that includes the established elevation, ii) a fixed point having the established elevation in the waterway, or iii) a crossing of a track of the vessel with a track of another vessel having the established elevation, among other possibilities. At 706, the system may determine the depths of the waterway based on the elevation data.

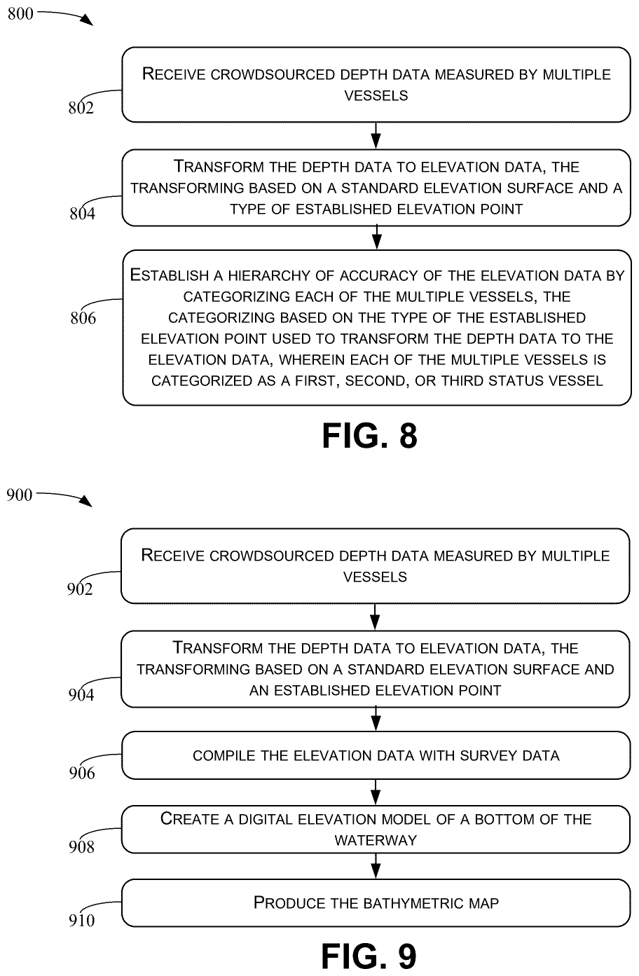

FIG. 8 is a flow diagram of a process 800 for determining depths of a waterway, according to other embodiments. Process 800, like 700, may be performed by a system that includes a processor executing programmed instructions, for example. At 802, the system may receive crowdsourced depth data measured by multiple vessels. At 804, the system may transform the depth data to elevation data. The transforming may be based on a standard elevation surface, such as NAVD88, and a type of established elevation point (an a priori known elevation). At 806, the system may establish a hierarchy of accuracy of the elevation data by categorizing each of the multiple vessels. The categorizing may be based on the type of the established elevation point used to transform the depth data to the elevation data. Each of the multiple vessels may be categorized as a primary, second, or tertiary status vessel.

FIG. 9 is a flow diagram of a process 900 for producing a bathymetric map of a waterway, according to some embodiments. Process 900 may be performed by a system that includes a processor executing programmed instructions, for example. At 902, the system may receive crowdsourced depth data measured by multiple vessels. At 904, the system may transform the depth data to elevation data. The transforming may be based on a standard elevation surface and a point or location having an elevation that is well-known, constant, established, and/or defined as a standard elevation, for example. At 906, the system may compile the elevation data with survey data. For example, various functions or operations may be applied to the elevation data and the survey data during a compile process. At 908, the system, from the compiled elevation data and survey data, may create a digital elevation model of a bottom portion of the waterway. At 910, the system may produce the bathymetric map based on the digital elevation model.

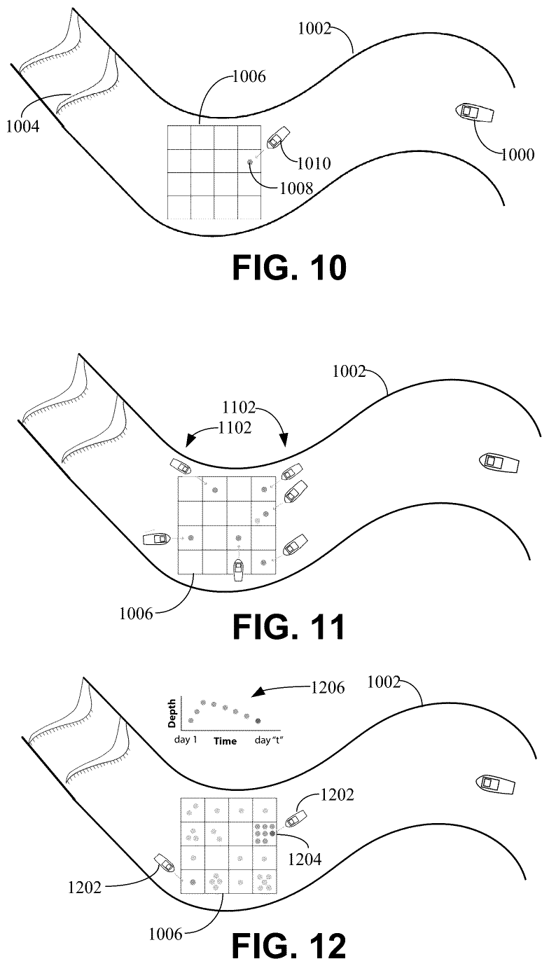

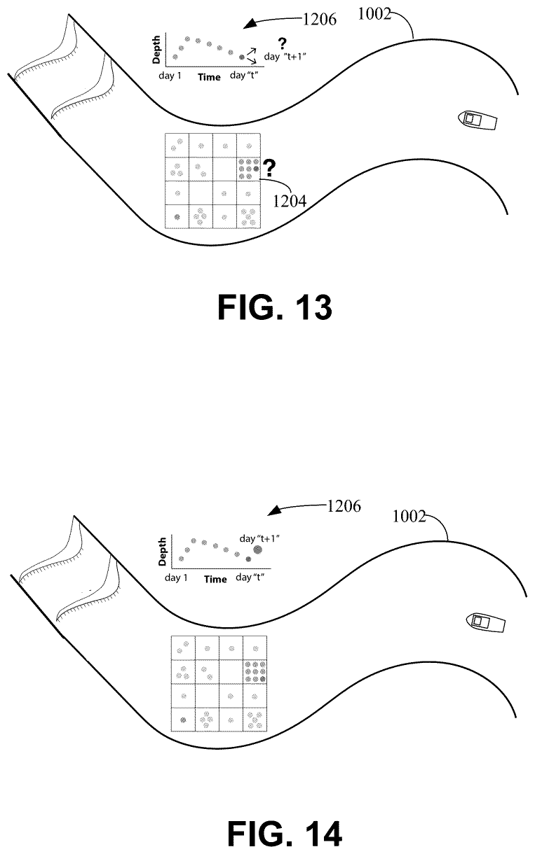

FIGS. 10-17 illustrate a process, and situations that may be involved in the process, for producing a shoaling report, forecast, or a bathymetric map of a waterway that carries vessels 1000, according to some embodiments. In particular, FIG. 10 includes a waterway 1002, bedforms 1004, and a virtual grid 1006 in a particular region of interest. In some implementations, bedforms may be reported and/or their depths detailed in a shoaling report or forecast, for example. A point 1008 indicates a portion of grid 1006 where a vessel 1010 measured a depth of the waterway on a first day, for example. FIG. 11 illustrates a number of additional vessels 1102 and points in multiple portions of grid 1006 where the vessels measured depths of the waterway on a second day. Point 1008 from the previous day is included. FIG. 12 illustrates additional vessels 1202 and additional points in multiple portions of grid 1006 where the vessels measured depths of the waterway on an Nth day. A portion 1204 of grid 1006, for example, includes eight depth measurements, likely made by eight different vessels (though this need not be the case) during the N days. In some embodiments, such as those described above, the depth measurements (e.g., depth data) may be transformed to elevation data, based on NAVD88, for example. Graph inset 1206 illustrates the eight elevation data values plotted over a time scale. The eight example elevation data values display an increasing trend of depth and a subsequent shallowing over time in portion 1204 of (grid 1006 of) waterway 1002. FIG. 13 illustrates an uncertainty about the depth of portion 1204 on a subsequent day (e.g., N+1). For example, the depth in this portion of waterway 1002 may increase or decrease, depending on many factors, such as season of the year, currents, tides, dredging activities, and water volume, just to name a few examples. Based on such affecting variables, and a history of measured depth data for this and other portions of the waterway, the depth for a subsequent day may be predicted, as illustrated in FIG. 14. Such a prediction, or forecast, may be performed by embodiments, such as those described below.

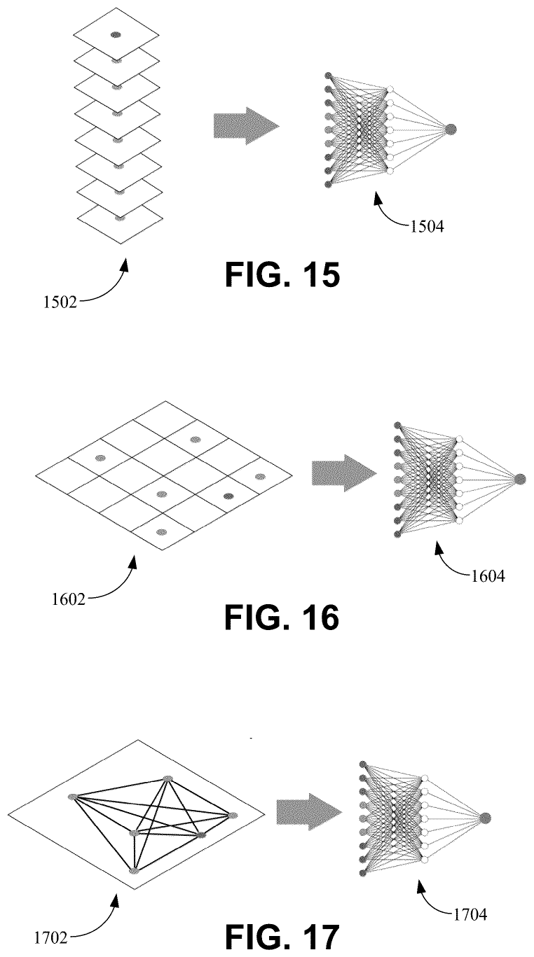

FIG. 15 schematically illustrates a part of a process of sequence-based depth forecasts for a waterway, according to some embodiments. Spatiotemporal elevation data sequences (e.g., derived from depth data) 1502 may be processed by machine-learning (ML) 1504. In addition to spatiotemporal elevation data, other variables may be processed by ML 1504. Other exogenous variables may include hydrographic and sediment transport measurements, dredging metrics, morphological/geomorphological metrics, and encoded spatial or temporal information (e.g., site/grid location, season of year, etc.), just to name a few examples. ML 1504 may process such data and produce a predicted depth value for a particular portion (or point) of the waterway.

FIG. 16 schematically illustrates a part of a process of image-based depth forecasts for a waterway, according to some embodiments. Spatiotemporal elevation data (e.g., derived from depth data) 1602 provided to an MLA 1604 may be represented as an image (e.g., comprising one or more color channels), image frame, grid (e.g., 1006), or raster array, for example. In addition to spatiotemporal elevation data, other exogenous variables may be processed by MLA 1604. Other variables, similar to or the same as those described above, may include hydrographic and sediment transport measurements, dredging metrics, morphological/geomorphological metrics, and encoded spatial or temporal information (e.g., site/grid location, season of year, etc.)-, just to name a few examples. MLA 1604 may process such data and produce a predicted depth value for a particular portion (or point) of the waterway.

FIG. 17 schematically illustrates a part of a process of graph-based depth forecasts for a waterway, according to some embodiments. Spatiotemporal elevation data (e.g., derived from depth data) 1702 provided to an MLA 1704 may be represented as a graph and these spatiotemporal elevation data may be associated/combined with various exogenous attributes, such as hydrographic and sediment transport measurements, dredging metrics, morphological/geomorphological metrics, and encoded spatial or temporal information (e.g., site/grid location, season of year, etc.), just to name a few examples. MLA 1704 may process such data and produce a predicted depth value for a particular portion (or point) of the waterway.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for determining depths of a waterway, the method comprising:
receiving data measured by a vessel in the waterway, the data being a part of crowdsourced data measured by multiple vessels;
transforming at least a portion of the data to elevation data, the transforming based on an elevation standard, water surface, and a location having an established elevation, wherein the location is i) determined from a bathymetric survey that includes the established elevation, ii) a fixed point in the waterway, or iii) a crossing of a track of the vessel with a track of another vessel having the established elevation; and
determining the depths of the waterway based on the elevation data.

2. The method of claim 1, further comprising assigning a status to each of the multiple vessels based on a quality of the data provided respectively by each of the multiple vessels, wherein a primary status corresponds to a relatively high quality of the data, a secondary status corresponds to a relatively medium quality of the data, and a tertiary status corresponds to a relatively low quality of the data.

3. The method of claim 2, wherein the location of the established elevation is the crossing of the track of the vessel with the track of the other vessel having the established elevation, wherein if the other vessel has the primary status then the vessel is assigned a secondary status, and wherein if the other vessel has a secondary status then the vessel is assigned a tertiary status.

4. The method of claim 3, wherein transforming the data from the vessel to the elevation data includes a process of identifying the data as being more accurate for the vessel having the secondary status than for the vessel having the tertiary status.

5. The method of claim 1, wherein the elevation standard is NAVD88.

6. The method of claim 1, wherein the data measured by the vessel in the waterway is received in near real-time and the depths of the waterway based on the elevation data is determined in near real-time.

7. The method of claim 1, further comprising automatically producing a bathymetric map in near real time referenced to a standard vertical datum and based on the determined depths of the waterway.

8. A method for determining depths of a waterway, the method comprising:
receiving crowdsourced data measured by multiple vessels;
transforming at least a portion of the data to elevation data, the transforming based on a standard elevation surface and a type of established elevation point;
establishing a hierarchy of accuracy of the elevation data by categorizing each of the multiple vessels, the categorizing based on the type of the established elevation point used to transform the data to the elevation data, wherein each of the multiple vessels is categorized as
a primary status vessel, corresponding to relatively high accuracy elevation data, if the type of established elevation point is a surveyed part of the waterway or a fixed point of known elevation in the waterway,
a second status vessel, corresponding to relatively medium accuracy elevation data, if the type of established elevation point is a track crossing with one of the primary status vessels,
a tertiary status vessel, corresponding to relatively low accuracy elevation data, if the type of established elevation point is a track crossing with one of the second status vessels; and
determining the depths of the waterway based on the high, medium, and low accuracy elevation data.

9. The method of claim 8, wherein each of the second status vessels have crossed tracks with at least one of the primary status vessels and each of the tertiary status vessels have crossed tracks with at least one of the second status vessels.

10. The method of claim 8, wherein the elevations are referenced to a standard vertical datum.

11. The method of claim 8, wherein the fixed point is a shipwreck or a submerged pipeline crossing.

12. The method of claim 8, further comprising producing a bathymetric map in near real-time based on the determined depths of the waterway.

13. A method for producing a bathymetric map of a waterway, the method comprising:
receiving crowdsourced data in real-time measured by multiple vessels;
transforming at least a portion of the data to elevation data, the transforming based on a standard elevation surface and an established elevation point;
compiling the elevation data with survey data;
automatically creating a digital elevation model of a bottom of the waterway; and
producing the bathymetric map in near real-time.

14. The method of claim 13, further comprising:
establishing a hierarchy of accuracy of the elevation data by assigning a status to each of the multiple vessels, the assigning based on the established elevation point used to transform the data to the elevation data, wherein each of the multiple vessels is assigned
a primary status, corresponding to relatively high accuracy elevation data, if the established elevation point is a surveyed part of the waterway or a fixed point of known elevation in the waterway,
a second status, corresponding to relatively medium accuracy elevation data, if the established elevation point is a track crossing with one of the primary status vessels,
a tertiary status, corresponding to relatively low accuracy elevation data, if the established elevation point is a track crossing with one of the second status vessels.

15. The method of claim 14, wherein each of the vessels having the second status have crossed tracks with at least one of the vessels having the primary status and each of the vessels having the tertiary status have crossed tracks with at least one of the vessels having the second status.

16. The method of claim 14, wherein the status of a particular vessel among the multiple vessels is based on a first established elevation point, the method further comprising changing the status of the particular vessel in response to the particular vessel crossing a second established elevation point that is a type that is different than the type of the first established elevation point.

17. The method of claim 14, the method further comprising changing the status of a particular vessel among the multiple vessels in response to an expiration of a time span of validity.

18. The method of claim 14, the method further comprising changing the status of a particular vessel among the multiple vessels in response to the particular vessel traveling beyond a threshold distance.

19. The method of claim 13, wherein the standard elevation surface is NAVD88.

20. The method of claim 13, wherein the fixed point is a shipwreck or a submerged pipeline crossing.
